(19) United States
(12) Patent Application Publication
(10) Pub. No.: US 2009/0265039 A1
(43) Pub. Date: Oct. 22, 2009

(54) SUBSTRATE PROCESSING APPARATUS, SUBSTRATE PROCESSING METHOD AND STORAGE MEDIUM

(75) Inventor: Yuji Kamikawa, Tosu City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/418,305

(22) Filed: Apr. 3, 2009

(30) Foreign Application Priority Data
Apr. 3, 2008 (JP) 2008-097058

(51) Int. Cl. G05D 7/06

(52) U.S. Cl. 700/285; 700/282

(57) ABSTRACT

A substrate processing apparatus capable of reducing a consumed amount of a processing liquid is provided. The substrate processing apparatus includes a plurality of processing units 22-1 to 22-6 to perform liquid processing on a substrate by using a processing liquid, a processing liquid supply pipe 210 to supply the processing liquid in common to the plurality of processing units 22-1 to 22-6, and a flow control part 220 to control a flow rate of the processing liquid within the processing liquid supply pipe 210 to be increased or decreased according to a number of operating processing units from among the plurality of processing units 22-1 to 22-6.

This application is based on and claims priority from Japanese Patent Application No. 2008-097058, filed on Apr. 3, 2008 in the Japanese Patent Office, the disclosure of which is incorporated herein in its entirety by reference.

### TECHNICAL FIELD

The present invention relates to a substrate processing apparatus and method for supplying a processing liquid to a substrate, such as a semiconductor wafer or a flat panel display, and performing liquid processing, such as cleaning, on the substrate. Also, the present invention relates a storage medium for controlling the substrate processing apparatus.

### BACKGROUND

A process of manufacturing a semiconductor device or a flat panel display (FPD) includes performing liquid processing by supplying a processing liquid to a substrate, such as a semiconductor wafer or a glass substrate. For example, liquid processing includes removing particles or contaminants attached to a substrate (cleaning process).

A substrate processing apparatus performs liquid processing by supplying a processing liquid, such as, a cleaning liquid to a substrate, such as, a semiconductor wafer while rotating the substrate supported by a spin chuck. During the liquid processing the processing liquid is generally supplied to the center of a wafer. Thus, the processing liquid diffuses outward the substrate due to the rotation of the substrate, thereby forming a liquid film.

As an example of a cleaning liquid used in a cleaning process, there is an alkaline processing liquid or diluted hydrofluoric acid. The alkaline processing liquid is prepared by mixing alkaline ammonia with hydrogen peroxide and/or deionized water. The diluted hydrofluoric acid is prepared by diluting hydrofluoric acid with deionized water.

Japan Patent Laid-open Publication No. 2001-87722 discloses a substrate processing apparatus in which a processing liquid is formed by injecting ammonia or hydrofluoric acid in a pipe where deionized water flows, and forming a processing liquid in a certain concentration range within the pipe just before supplying the processing liquid to a substrate.

Although the substrate processing apparatus described in Japan Patent Laid-open Publication No. 2001-87722 includes only one processing unit, substrate processing apparatuses employing the method described in Japan Patent Laid-open Publication No. 2001-87722 may include multiple processing units so as to improve workability of the apparatus. Thus, the method of Japan Patent Laid-open Publication No. 2001-87722 may be applicable to a multi-unit substrate processing apparatus.

In a multi-unit substrate processing apparatus, a common processing liquid supply pipe is provided to all units, and a processing liquid is supplied to the common processing liquid supply pipe at a flow rate with which the processing liquid can be supplied to all units. For example, if there are twelve processing units and a flow rate of each unit is 3 l/min, the processing liquid is supplied to the common processing liquid supply pipe at a flow rate of 36 l/min.

However, in a case where only one unit operates, whole amount of the processing liquid for all units is supplied to the processing liquid supply pipe. Thus, the processing liquid supplied to non-operating units is unnecessarily wasted.

### SUMMARY

The present invention provides a substrate processing apparatus and method capable of reducing a consumed amount of a processing liquid, and a storage medium storing a program to control the apparatus by the method.

According to one example, a substrate processing apparatus is provided. The substrate processing apparatus includes a plurality of processing units to perform liquid processing on a substrate by using a processing liquid, a processing liquid supply pipe to supply the processing liquid in common to the plurality of processing units, and a flow control part to control a flow rate of the processing liquid within the processing liquid supply pipe to be increased or decreased according to a number of operating processing units from among the plurality of processing units. In some examples, the flow control part increases the flow rate of the processing liquid within the processing liquid supply pipe before a newly operating processing unit from among the plurality of processing units operates.

According to another example, a method of liquid processing of a substrate processing apparatus is provided. The method includes supplying a processing liquid in common from a processing liquid supply pipe to a plurality of processing units, and controlling a flow rate of the processing liquid flowing within the processing liquid supply pipe to be increased or decreased according to a number of operating processing units from among the plurality of processing units.

According to still another example, a computer-readable storage medium is provided. The storage medium is executed by a computer and stores a substrate processing control program. The control program may control the substrate processing apparatus to perform the method through the computer.

### BRIEF DESCRIPTION OF THE DRAWINGS

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

FIG. 1 is a plane view illustrating the schematic configuration of a substrate processing apparatus according to a first example of the present invention;

FIG. 2 is an enlarged cross sectional view of a processing unit;

FIG. 3 is a block diagram illustrating a configuration of a substrate processing apparatus according to one example;

FIG. 4 illustrates one example of a flow rate control;

FIG. 5 illustrates another example of a flow rate control;

FIG. 6 is a block diagram illustrating an example of a substrate processing apparatus which controls back pressure;

FIG. 7 is a block diagram illustrating a configuration of a substrate processing apparatus according to a second example of the present invention;

FIG. 8a is a graph illustrating the correlation between the flow rates of first and second liquids and time;

FIG. 8b is a graph illustrating the correlation between the concentration of a processing liquid and time;

FIG. 8c is a graph illustrating the correlation between a timing at which the flow rate of a processing liquid is increased and the concentration of a processing liquid;

FIG. 9a is a graph illustrating the correlation between the flow rates of first and second liquids and time;

FIG. 9b is a graph illustrating the correlation between the concentration of a processing liquid and time;

FIG. 9c is a graph illustrating the correlation between a timing at which the flow rate of a processing liquid is increased and the concentration of a processing liquid;

FIG. 10a is a graph illustrating the correlation between the flow rates of first and second liquids and time;

FIG. 10b is a graph illustrating the correlation between the concentration of a processing liquid and time;

FIG. 11a is a graph illustrating the correlation between the flow rates of first and second liquids and time;

FIG. 11b is a graph illustrating the correlation between the concentration of a processing liquid and time;

FIG. 11c is a graph illustrating the correlation between a timing at which the flow rate of a processing liquid is decreased and the concentration of a processing liquid;

FIG. 12a is a graph illustrating the correlation between the flow rates of first and second liquids and time;

FIG. 12b is a graph illustrating the correlation between the concentration of a processing liquid and time;

FIG. 12c is a graph illustrating the correlation between a timing at which the flow rate of a processing liquid is decreased and the concentration of a processing liquid;

FIG. 13a is a graph illustrating the correlation between the flow rates of first and second liquids and time;

FIG. 13b is a graph illustrating the correlation between the concentration of a processing liquid and time; and

FIG. 14 is a graph illustrating the correlation between a timing at which the flow rates of a processing liquid is increased and the start of processing.

### DETAILED DESCRIPTION

Hereinafter, an exemplary embodiment of the present invention will be described with reference to the accompanying drawings. In the following description and drawings, the same reference numerals are used to designate the same or similar components. For the purpose of description, it is illustrated that the present invention is applied to a liquid processing apparatus for cleaning both front and rear surfaces of a semiconductor wafer (hereinafter, referred to as a wafer).

### First Example

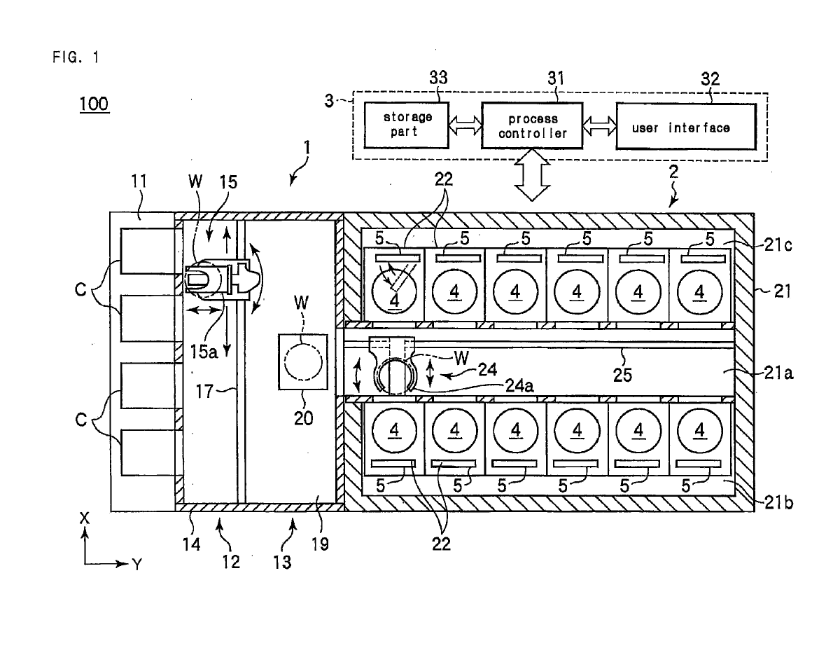

FIG. 1 is a plane view illustrating the schematic configuration of a substrate processing apparatus according to a first example of the present invention.

A substrate processing apparatus 100 includes a loading/unloading station (substrate loading/unloading) 1 to arrange a wafer carrier C which accommodates a plurality of wafers W, and to load or unload the wafers W, a processing station (a liquid processing unit) 2 to perform cleaning of the wafer W, and a control unit 3. The stations 1 and 2 and the unit 3 are adjacently installed to each other.

The loading/unloading station 1 includes a carrier arranging part 11 to arrange the wafer carrier C which accommodates a plurality of wafers W in a horizontal state, a carrying part 12 to carry a wafer W, a transfer part 13 to transfer the wafer W, and a case 14 to house the carrying part 12 and the transfer part 13.

The carrier arranging part 11 may arrange four wafer carriers C, and the arranged wafer carriers C are closely adhered to the vertical wall of the case 14. Each of the wafer carriers C is configured in such a manner that its cover can be opened and thus allows the wafer W within the wafer carrier C to be loaded in the carrying part 12.

The carrying part 12 includes a carrying device 15. The carrying device 15 includes a wafer holding arm 15a to hold the wafer W, a device to move the wafer holding arm 15a in a Y-direction perpendicular to the arrangement direction of the wafer carrier C, a device to move the wafer holding arm 15a along a horizontal guide 17 extending in a X-direction, i.e. the arrangement direction of the wafer carrier C, a device to move the wafer holding arm 15a along a vertical guide (not shown) installed in a vertical direction, and a device to rotate the wafer holding arm 15a in a horizontal plane. The carrying device 15 carries the wafer W between the wafer carrier C and the transfer part 13.

The transfer part 13 includes a transfer stage 19, and a transfer shelf 20. The transfer shelf 20 includes a plurality of arranging parts to arrange the wafer W provided on the transfer stage 19. The transfer shelf 20 allows the wafer W to be transferred to the processing station 2.

The processing station 2 has a rectangular-parallelepiped-shaped case 21. The case 21 includes a carrying chamber 21a and two unit chambers 21b and 21c installed at both sides of the carrying chamber 21a. The carrying chamber 21a includes a carrying path in its upper central portion. The carrying path extends in a Y-direction perpendicular to the arrangement direction (X-direction) of the wafer carrier C.

A carrying device 24 is provided within the carrying chamber 21a. The carrying device 24 has a wafer holding arm 24a to hold a wafer W, a device to move the wafer holding arm 24a in a X-direction, a device to move the wafer holding arm 24a in a Y-direction along a horizontal guide 25 installed in the carrying chamber 21a, a device to move the wafer holding arm 24a along a vertical guide (not shown) installed in a vertical direction, and a device to rotate the wafer holding arm 24a in a horizontal plane. The carrying device 24 loads/unloads the wafer W to/from a processing unit (liquid processing unit) 22.

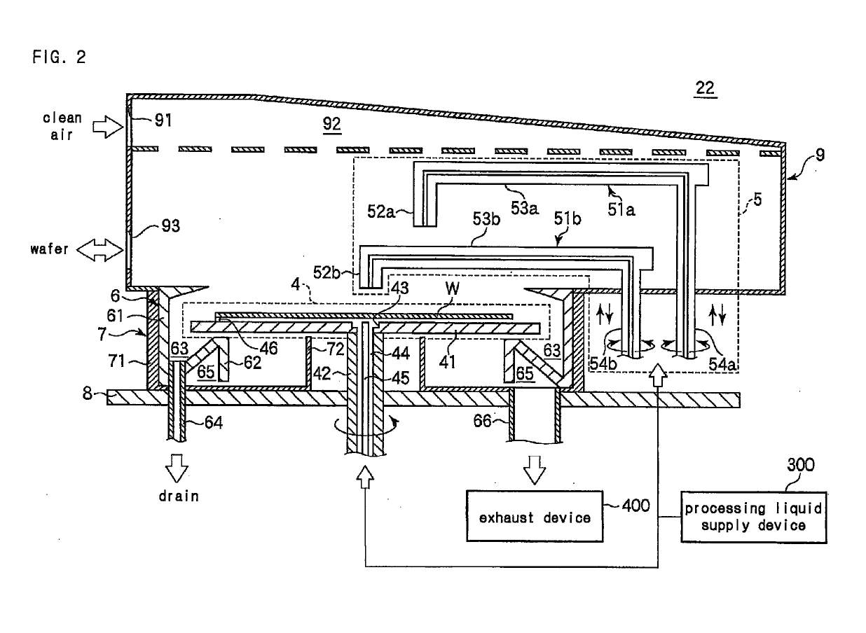

The unit chambers 21b and 21c are shared by a plurality of the processing units 22, in which the plurality of the processing units 22 is disposed. In some examples, twelve processing units 22 (six units in each of the unit chambers 21b and 21c) are horizontally disposed along the carrying chamber 21a. The enlarged cross sectional view of one of the processing units 22 is shown in FIG. 2.

As shown in FIG. 2, the processing unit 22 includes a wafer holding part 4 to hold a wafer W, a processing liquid supply device 5 to supply a processing liquid to the wafer W supported by the wafer holding part 4, a drain cup 6 installed over between the outside and underside the wafer holding part 4, the drain cup 6 being capable of withdrawing the processing liquid supplied to the wafer W, and an outside cup 7 installed in the outside the drain cup 6.

The wafer holding part 4 according to one example includes a horizontally provided disk-shaped rotating plate 41, and a cylindrical rotating shaft 42. The cylindrical rotating shaft 42 extends in a vertical downward direction, and is connected to the center of the rear surface of the rotating plate 41. A circular hole 43 is formed at the center of the rotating plate 41, and the hole 43 is communicated with the hole 44 of the cylindrical rotating shaft 42. A liquid supply nozzle 45 for the rear surface is provided within the holes 43 and 44. A processing liquid is supplied from a processing liquid supply device 300 to the liquid supply nozzle 45 for the rear surface. The rotating plate 41 includes a support member 46 to support the outer edge of the wafer W. Although only one support member 46 is shown in FIG. 2, three support members may be arranged with uniform spacing. The support member 46 horizontally supports the wafer W which is apart from the rotating plate 41.

The processing liquid supply device 5 according to the present embodiment includes a first processing liquid supply part 51a to supply an alkali-containing processing liquid, and a second processing liquid supply part 51b to supply an acid-containing processing liquid. A processing liquid is supplied from the processing liquid supply device 300 to the processing liquid supply device 5.

The first processing liquid supply part 51a includes a nozzle 52a to discharge the alkali-containing processing liquid. An example of the alkali-containing processing liquid may include a processing liquid containing ammonia as alkali. For example, the alkali-containing processing liquid may include an alkaline processing liquid prepared by mixing ammonia (alkali) with hydrogen peroxide and/or water. Otherwise, other similar cleaning liquids may be used. The nozzle 52a is attached to the leading end of a first scanning arm 53a. The first scanning arm 53a is connected to a shaft 54a. By rotating the shaft 54a, the first scanning arm 53a is configured to allow the nozzle 52a attached to the leading end to carry out a scan between a stand-by position on the outside the wafer holding part 4 and a processing position above the wafer W. Also, the shaft 54a can rise upwardly and fall downwardly. For example, with the rising and falling of the shaft 54a at the processing position, the discharge position (height) of the nozzle 52a can be adjusted.

The second processing liquid supply part 51b includes a nozzle 52b to discharge the acid-containing processing liquid. An example of the acid-containing processing liquid may include a processing liquid containing hydrofluoric acid as acid. In some examples, the acid-containing processing liquid may include an acidic processing liquid, such as diluted hydrofluoric acid, prepared by diluting hydrofluoric acid with water or the like. The nozzle 52b is attached to the leading end of a scanning arm, that is, a second scanning arm 53b in the illustrated example, in the same manner as the nozzle 52a. The position of the second scanning arm 53b is lower than that of the first scanning arm 53a. The second scanning arm 53b is connected to a shaft 54b, and the second scanning arm 53a is configured to allow the nozzle 52b to carry out a scan between the stand-by position and the processing position, by rotating the shaft 54b. Also, the shaft 54b can rise upwardly and fall downwardly. For example, the discharge position (height) of the nozzle 52b can be adjusted at the processing position.

In some examples, the drain cup 6 includes a cylindrical outer peripheral wall 61, an inner wall 62 extending from the lower end of the outer peripheral wall 61 toward the inside, and a liquid-receptacle 63. The liquid-receptacle 63 refers to an annular space defined by the outer peripheral wall 61 and the inner wall 62 and it withdraws and accommodates a processing liquid. The liquid-receptacle 63 is connected to a drainage pipe 64 to drain the withdrawn processing liquid. The drainage pipe 64 is connected to a drain. Also, an annular space communicating with a lower space of the wafer holding part 4 is formed below the liquid-receptacle 63. The annular space functions as an exhaust space 65. The exhaust space 65 is connected to an exhaust pipe 66 which is connected to an exhaust device 400.

In some examples, the outside cup 7 includes a cylindrical outer wall 71 and an inner wall 72. The inner wall 72 extends from the outer wall 71 toward the underside the wafer holding part 4, and is located at a position nearer to the rotating shaft 42 than that to the drain cup 6. In some examples, the drain cup 6 is received in a space between the outer wall 71 and the inner wall 72. The outside cup 7 is attached onto a base plate 8.

Above the outside cup 7, a casing 9 is installed to cover the wafer W, the wafer holding part 4, the processing liquid supply device 5, the drain cup 6, and the upper portion of the outside cup 7. An air-flow inlet part 92 is installed in the upper portion of the casing 9 to introduce air flow from a fan filter unit (FFU, not shown) via an inlet 91 provided in the lateral portion of the casing 9. The air-flow inlet part 92 supplies clean air as a down flow to the wafer W supported by the wafer holding part 4. The supplied clean air is exhausted via the above mentioned exhaust pipe 66.

Also, a substrate loading/unloading port 93 is formed in the lateral portion of the casing 9. The wafer W is loaded/unloaded via the substrate loading/unloading port 93 into/from the inside the casing 6.

Referring again to FIG. 1, the control unit 3 to control the substrate processing apparatus 100 includes a process controller 31 (for example, a computer), a user interface 32 connected to the process controller 31, and a storage part 33 connected to the process controller 31.

The user interface 32 includes a keyboard by which an operator can input a command to control the substrate processing apparatus 100, and a display to show the operation state of the substrate processing apparatus 100, etc.

The storage part 33 may store a recipe such as a control program to control the processes of the substrate processing apparatus 100 with the process controller 31, or a program to allow the substrate processing apparatus 100 to perform a processing according to processing conditions. The recipe is stored in a storage medium within the storage part 33. The storage medium is a computer-readable storage medium. The storage medium may be a hard disc, a semiconductor storage part, or a portable medium such as a CD-ROM, a DVD, or a flash storage part. A recipe is read from the storage part 33 in response to the instruction from the user interface 32. A substrate processing is performed by the substrate processing apparatus 100 under the control of the process controller 31 when the read recipe is performed in the process controller 31. For example, the recipe may be appropriately transmitted from another apparatus to the storage part 33 via an exclusive line.

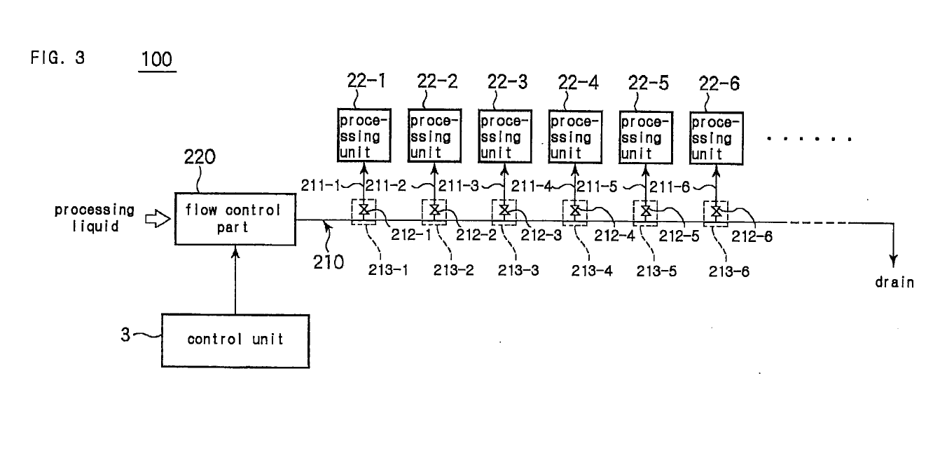

FIG. 3 is a block diagram illustrating a configuration of a substrate processing apparatus according to one example.

As shown in FIG. 3, the substrate processing apparatus 100 according to one example includes a plurality of processing units 22-1 to 22-6 to perform liquid processing of a wafer with a processing liquid, a common processing liquid supply pipe 210 to supply the processing liquid to the processing units 22-1 to 22-6, and a flow control part 220 to control the flow rate of the processing liquid within the processing liquid supply pipe 210. The processing liquid is supplied to the processing units 22-1 to 22-6 through the processing liquid supply pipe 210 and a plurality of branch pipes 211-1 to 211-6. The plurality of branch pipes 211-1 to 211-6 is diverged from the processing liquid supply pipe 210, and connected to the processing units 22-1 to 22-6. The branch pipes 211-1 to 211-6 include switch valves 212-1 to 212-6 near branch parts where the branch pipes 211-1 to 211-6 are diverged from the processing liquid supply pipe 210. The processing liquid always flows into the processing supply pipe 210 during supplying of the processing liquid to the processing units 22-1 to 22-6. Further, by opening or closing each switch valve, the processing liquid can be supplied to the processing units or the supplying of the processing liquid can be stopped. Each switch valve and each branch part are integrated to form each unit 213-1 to 213-6 of the branch part and the switch valve. With the integrated units 213-1 to 213-6, each unit composed of each branch part and each valve, the distances between the branch parts and the switch valves can be shorten, and thus the pooling of the processing liquid can be prevented.

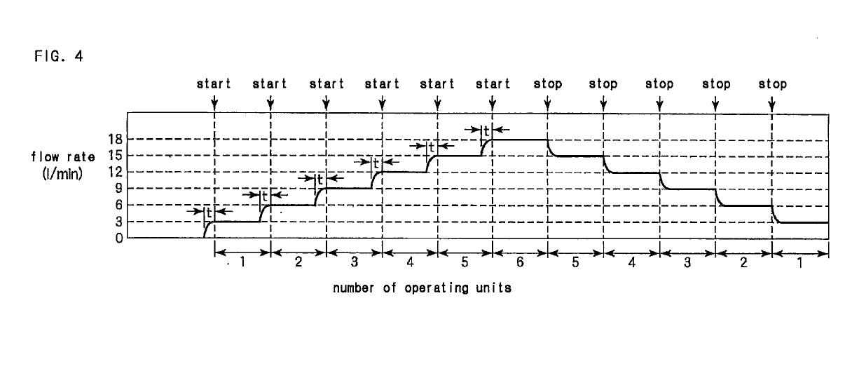

The flow control part 220 controls the flow rate of the processing liquid flowing within the processing liquid supply pipe 210 so that the flow rate of the processing liquid is increased or decreased according to the number of operating units of the processing units 22-1 to 22-6. In some examples, the flow control part 220 is controlled by the control unit 3. The control unit 3 determines the number of operating processing units, and based on the determined number, instructs the flow control part 220 to increase or decrease the flow rate to a level required for the operating processing units. The flow control part 220 increases or decreases the flow rate of the processing liquid within the processing liquid supply pipe 210, in response to the instruction. One example of flow control is illustrated in FIG. 4. In FIG. 4, it is assumed that a processing liquid is in common supplied to six processing units 22-1 to 22-6, and a flow rate of the processing liquid in one processing unit is 3 l/min.

As shown in FIG. 4, when no processing unit operates, the flow control part 220 sets the flow rate of the processing liquid to zero. When one processing unit is operating, the flow control part 220 supplies the processing liquid to the common processing liquid supply pipe 210 at a flow rate of 3 l/min. Also, the flow control part 220 increases the flow rate according to the number of operating processing units, such as 6 l/min for two operating processing units, 9 l/min for three operating processing units, . . . , 18 l/min for six operating processing units. On the other hand, when the number of operating processing units decreases, the flow control part 220 decreases the flow rate from 18 l/min to 15 l/min, 12 l/min, . . . , and then when the number of the operating processing units reaches zero, it sets the flow rate of the processing liquid to zero.

Also, although in FIG. 4 the number of operating processing units increases stepwise from one to six, or decreases stepwise from six to one, the number of the operating processing units may randomly change, for example, from two to four, from four to one, from one to six, etc. In this case, the flow control part 220 may control the flow rate of the processing liquid to be increased from 6 l/min to 12 l/min, to be decreased from 12 l/min to 3 l/min, or to be increased from 3 l/min to 18 l/min, for example.

Also, the substrate processing apparatus 100 according to the illustrated example sets a timing for increasing the flow rate of a processing liquid prior to the start timing of unit operation (time ‘t’ in FIG. 4). The flow control part 220 increases the flow rate of the processing liquid before the unit operation is started, and thus can stabilize the flow rate of the processing liquid flowing within the common processing liquid supply pipe 210 to a predetermined level for all operating units at the time the unit operation is started. Accordingly, the shortage of the processing liquid flowing within the common processing liquid supply pipe 210 can be prevented during unit operation. In order to set the increasing timing of the flow rate of the processing liquid prior to the start timing of unit operation, the control unit 3 may control the flow control part 220 to increase the flow rate of the processing liquid while allowing several pre-start processes, such as, introduction of a wafer W into the substrate processing apparatus 100, or transfer of the wafer W to the carrying device 24, to be performed.

As described above, the substrate processing apparatus 100 according to one example increases or decreases the flow rate of the processing liquid (that is supplied from the processing liquid supply device 300) according to the number of operating processing units, thereby reducing the total amount of the processing liquid required for the processing units. Accordingly, the substrate processing apparatus according to one example can significantly reduce a consumed amount of the processing liquid, compared to a conventional substrate processing apparatus in which an amount of the processing liquid for all units is supplied regardless of the number of operating units.

Also, as described above, since the increasing timing of the flow rate of a processing liquid is set prior to the start timing of unit operation in the substrate processing apparatus 100 according to one example, a consumed amount of the processing liquid can be reduced and the shortage of the amount of the processing liquid flowing within the common processing liquid supply pipe 210 during unit operation can be prevented.

Also, a timing in which a flow rate of the processing liquid is stabilized can be set. Thus, the flow control part 220 may increase the flow rate of the processing liquid within the processing liquid supply pipe 210 in such a manner that a newly operating processing unit can operate after the flow rate of the processing liquid within the processing liquid supply pipe 210 is stabilized.

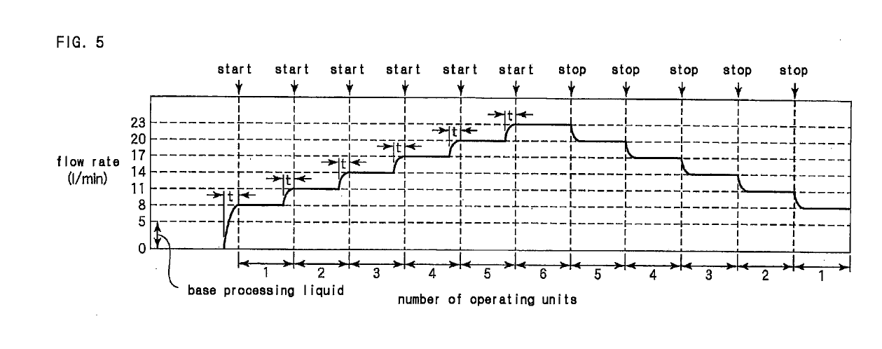

FIG. 5 shows another example of flow rate control.

The flow rate control shown in FIG. 5 is different from that in FIG. 4 in that it allows a base processing liquid, besides the processing liquid used by the processing units 22-1 to 22-6, to flow within the common processing liquid supply pipe 210. The error in a flow rate of a processing liquid may be precisely controlled by allowing the base processing liquid to flow within the common processing liquid supply pipe 210. For example, the storage of the processing liquid flowing within the common processing liquid supply pipe 210 can be prevented by additionally allowing the base processing liquid within the common processing liquid supply pipe 210 even when there is an error in a flow rate of the processing liquid used by the processing units 22-1 to 22-6. For example, assuming that the flow control part 220 supplies a processing liquid to the common processing liquid supply pipe 210 at a precisely controlled flow rate of 3 l/min for one unit, if any one of the processing units 22-1 to 22-6 consumes a processing liquid at the flow rate of 3.1 l/min, instead of 3 l/min, from the common processing liquid supply pipe 210, some other processing units will suffer the shortage of the processing liquid during unit operation. Such a problem may be solved by additionally allowing an extra base processing liquid, besides the processing liquid used by the processing units 22-1 to 22-6, to flow within the common processing liquid supply pipe 210. In this example, the base processing liquid flows in a flow rate of 5 l/min.

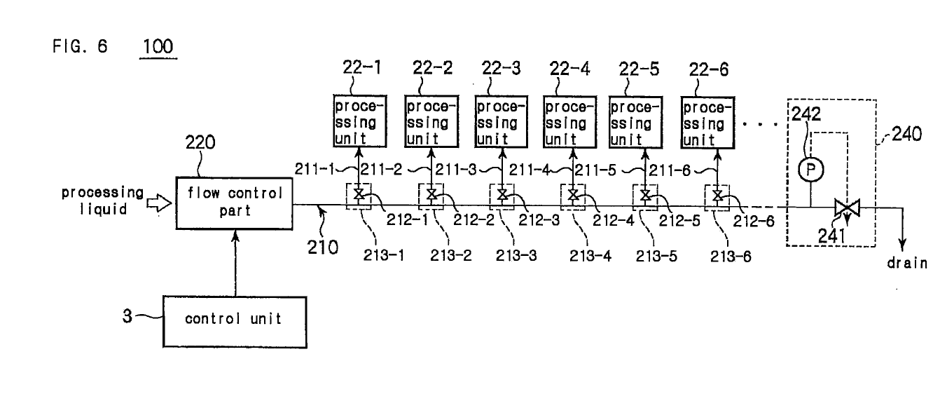

Also, in the substrate processing apparatus 100 according to the illustrated example, the flow rate of the processing liquid flowing within the common processing liquid supply pipe 210 is changed according to the number of operating processing units. Accordingly, the pressure within the common processing liquid supply pipe 210 changes according to the number of operating processing units. This pressure changing within the common processing liquid supply pipe 210 may change the amount of the processing liquid to be discharged into the processing units 22-1 to 22-6. In order to avoid the change in the discharged amount back pressure may be controlled to uniformly maintain the pressure within the common processing liquid supply pipe 210 when the flow rate of the processing liquid within the common processing liquid supply pipe 210 is changed. An example of a substrate processing apparatus which controls back pressure is shown in FIG. 6.

As shown in FIG. 6, a back pressure control part 240 in the common processing liquid supply pipe 210 is provided in a portion between the processing unit (“last processing unit”) arranged at the end of the sequence of the processing units 22-1 to 22-6 and the drain. The back pressure control part 240 changes the back pressure of the processing liquid according to a change in the flow rate of the processing liquid within the common processing liquid supply pipe 210. Thus, even after the flow control part 220 has changed the flow rate of the processing liquid, the pressure within the processing liquid supply pipe 210 can be controlled to have a uniform value.

One example of the back pressure control part 240 in the common processing liquid supply pipe 210, as shown in FIG. 6, has a back pressure control valve 241 provided between the last processing unit and the drain, and a pressure measuring part 242 provided between the last processing unit and the back pressure control valve 241. The pressure measuring part 242 measures the pressure between the back pressure control valve 241 and a portion connected to the processing units 22-1 to 22-6 in the common processing liquid supply pipe 210. Based on the measurement of the pressure measuring part 242, the back pressure control valve 241 adjusts the degree of the valve opening so as to uniformly maintain the pressure within the common processing liquid supply pipe 210 by using a predetermined pressure (back pressure). For example, when the pressure within the common processing liquid supply pipe 210 is higher than the predetermined pressure, the back pressure control valve 241 increases the degree of the valve opening so as to reduce the pressure to the predetermined pressure. On the other hand, when the pressure is lower than the predetermined pressure, the back pressure control valve 241 decreases the degree of the value opening so as to raise the pressure to the predetermined pressure.

As described above, when the substrate processing apparatus 100 according to one example employs an additional base processing liquid as well as the processing liquid used by the processing units 22-1 to 22-6, the shortage of the processing liquid during unit operation can be further prevented.

Also, the back pressure control part 240 may be further provided between a portion between the last processing unit in the common processing liquid supply pipe 210 and the drain. Thus, the pressure within the common processing liquid supply pipe 210 can be controlled uniformly regardless of a change in the number of operating processing units 22-1 to 22-6. Further, a change in the amount of the processing liquid to be discharged into the processing units 22-1 to 22-6 can be prevented.

### Second Example

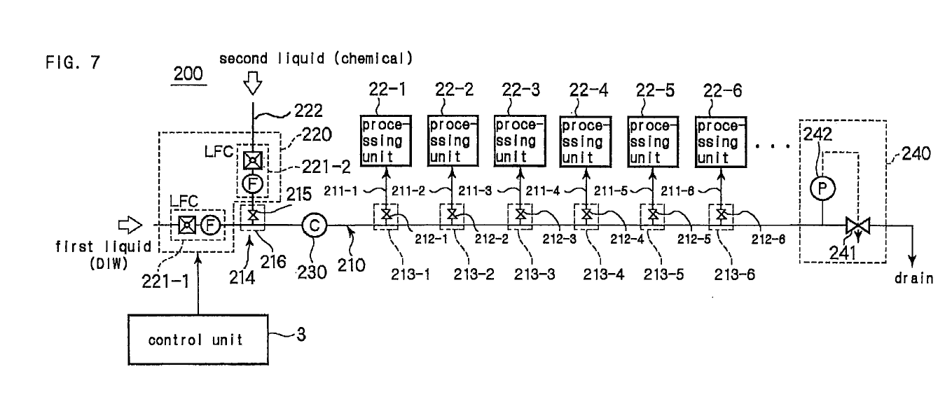

FIG. 7 is a block diagram illustrating a configuration of a substrate processing apparatus according to a second example of the present invention.

As shown in FIG. 7, a substrate processing apparatus 200 according to the second example is different from a substrate processing apparatus 100 according to the first example in that it allows different liquids to be mixed within a common processing liquid supply pipe 210 so that a processing liquid with a required concentration is obtained just before the liquid is supplied to a wafer W. Thus, besides the same configuration as that (as shown in FIG. 6) of the substrate processing apparatus 100 according to the first example, the substrate processing apparatus 200 further includes a mixing part 214. The mixing part 214 supplies a first liquid and a second liquid that is different from the first liquid within the common processing liquid supply pipe 210, and mixes the first liquid with the second liquid within the processing liquid supply pipe 210 to form a processing liquid. The second liquid is supplied to the mixing part 214 through a second liquid supply pipe 222. The mixing part 214 is provided at a joining part where the processing liquid supply pipe 210 and the second liquid supply pipe 222 meet to each other, and at the second liquid supply pipe 222. The mixing part 214 includes a unit 216 where a switch valve 215 to supply the second liquid or stop supplying of the second liquid is integrated to the joining part. With the mixing part 214 including the unit 216 of the joining part and the valve, the distance between the joining part and the switch valve 215 can be shorten and the pooling of the second liquid from pooling can be prevented.

A flow control part 220 is provided in the leading end of the mixing part 214. The flow control part 220 increases or decreases the flow rates of the first and second liquids according to the number of operating processing units from among a plurality of the processing units 22-1 to 22-6, and transfers the first and second liquids to the mixing part 214. Accordingly, in the same manner as described in the substrate processing apparatus 100, the substrate processing apparatus 200 increases or decreases the flow rate of the processing liquid within the common processing liquid supply pipe 210 according to the number of the operating processing units. The first and second liquids whose flow rates have been controlled are mixed in the mixing part 214 so as to form a processing liquid with a required concentration. The first liquid may be deionized water (DIW), and the second liquid to be added to the first liquid may be chemical. Examples of the chemical may include hydrofluoric acid (HF), hydrochloric acid (HCL), and ammonia (NH₃). In the present example, in the mixing part 214, deionized water may be mixed with hydrofluoric acid (HF), hydrochloric acid (HCL), or ammonia (NH₃) to form the processing liquid with a required concentration.

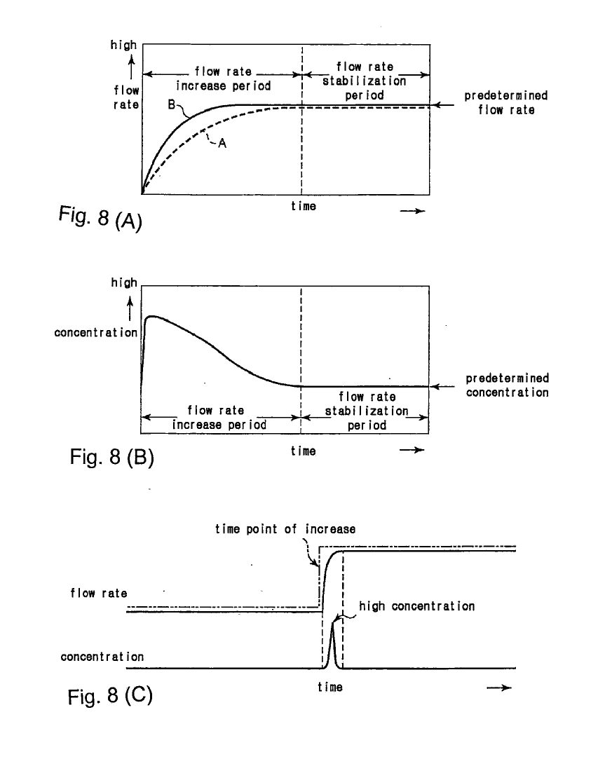

Also, the flow control part 220 is configured to control at least any one of an increase/decrease rate of the first liquid and an increase/decrease rate of the second liquid so that the concentration of the processing liquid can reach its preset concentration. Accordingly, the flow control part 220 includes a first liquid flow controller (LFC) 221-1 to control the flow rate of the first liquid, for example, deionized water (DIW) and the increase/decrease rate of the first liquid and to transfer the first liquid to the mixing part 214. The flow control part 220 further includes a second liquid flow controller (LFC) 221-2 to control the flow rate of the second liquid, for example, chemical and the increase/decrease rate of the second liquid, and to transfer the second liquid to the mixing part 214. Also, the start of supplying of the first liquid such as deionized water (DIW) is controlled by the first liquid flow controller (LFC) 221-1. The correlation between the flow rates of the first and second liquids and time is shown in FIG. 8a.

The first liquid A and the second liquid B have different viscosity values because they are different from each other. Due to such a difference, various characteristics such as an increase flow rate per unit time, an increasing method, or a time to reach a set flow rate, are different.

Especially, during a period where the flow rates of the first liquid A and the second liquid B are increased, as shown in FIG. 8a, the flow rates of the both liquids are different from each other due to the difference in the increase rate or the increasing method. For example, when the first liquid A is deionized water and the second liquid B is hydrofluoric acid, the flow rate of the hydrofluoric acid is more rapidly increased than that of the deionized water. Accordingly, as shown in FIG. 8b, during the flow rate increasing period, the mixing ratio of hydrofluoric acid and deionized water changes, thereby temporarily forming the processing liquid with a high concentration. The correlation between a timing at which a processing liquid is increased and the concentration of the processing liquid, is shown in FIG. 8c.

As shown in FIG. 8c, when the flow rate of the processing liquid is increased during the processing, the processing liquid temporarily has a high concentration during the increasing. Then, the high concentrated processing liquid is supplied to the processing unit via the processing liquid supply pipe 210. In a flow rate stabilized period, the mixing ratio of hydrofluoric acid and deionized water is returned to its predetermined ratio, thereby returning the concentration to its predetermined concentration. However, when a high concentrated processing liquid, that is, a processing liquid of which characteristic is changed, is even temporarily supplied to the processing unit, it is difficult to stably perform the liquid processing.

Therefore, in the present example, the increase rates of the flow rates of the first liquid A and the second liquid B are controlled by using the flow control part 220 so that a increasing or decreasing concentration of the processing liquid can reach its preset concentration.

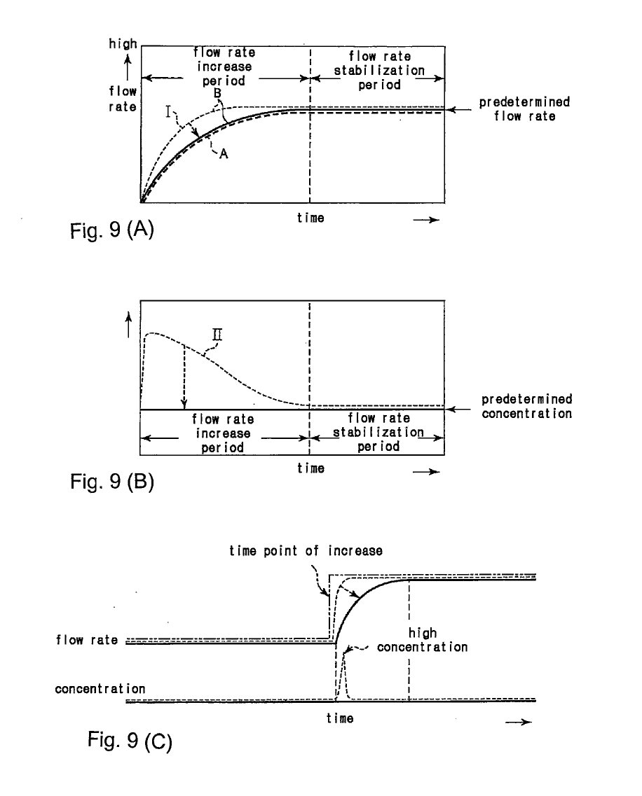

Specifically, as shown in dotted line I of FIG. 9a, when the flow rate of the second liquid B is more rapidly increased than that of the first liquid A, the increase rate of the flow rate of the second liquid B is increased up to a predetermined flow rate while being restrained. The increase rate of the flow rate of the second liquid B may be restrained in order to be similar to the increase rate of the flow rate of the first liquid A. For example, for unit time, the increase rate of the flow rate of the second liquid B can be controlled to be identical to that of the first liquid A.

The mixing ratio of the first and second liquids A and B can become varied so that the concentration of the processing liquid is deviated from a predetermined concentration. However, as shown in FIG. 9b, this deviation can be relieved even during a flow rate increase period when the increase rate of the flow rate of the second liquid B is controlled to be restrained, as compared to the case where the increase rate of the flow rate of the second liquid B is not restrained as shown in dotted line II.

Therefore, as shown in FIG. 9c, even when the flow rate of the processing liquid is increased during the liquid processing, the formation of a high concentrated processing liquid is restrained. Thus, a processing liquid having a stabilized concentration can be provided to the processing units via the processing liquid supply pipe 210.

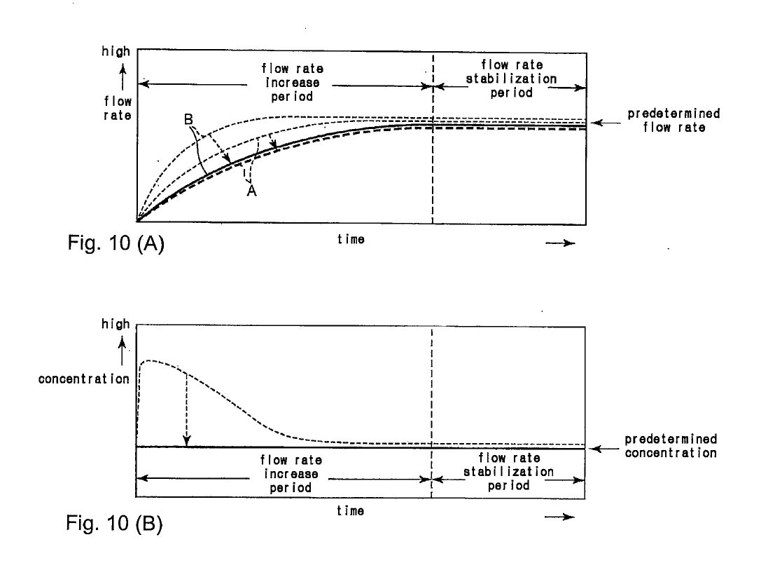

In the example as shown in FIGS. 9a to 9c, the increase rate of the flow rate of only the second liquid B is restrained. However, when the deviation of mixing ratio of first and second liquids A and B from a predetermined value can be prevented by restraining both increase rates of the flow rates of the first and second liquids A and B, the increase rates of the flow rates of both liquids A and B as shown in FIGS. 10a to 10b may be restrained.

Also, in this example, the flow control part 220 decreases the flow rate of a processing liquid according to the number of operating processing units. In some examples, the decrease in the flow rate of a processing late also can change the concentration of the processing liquid.

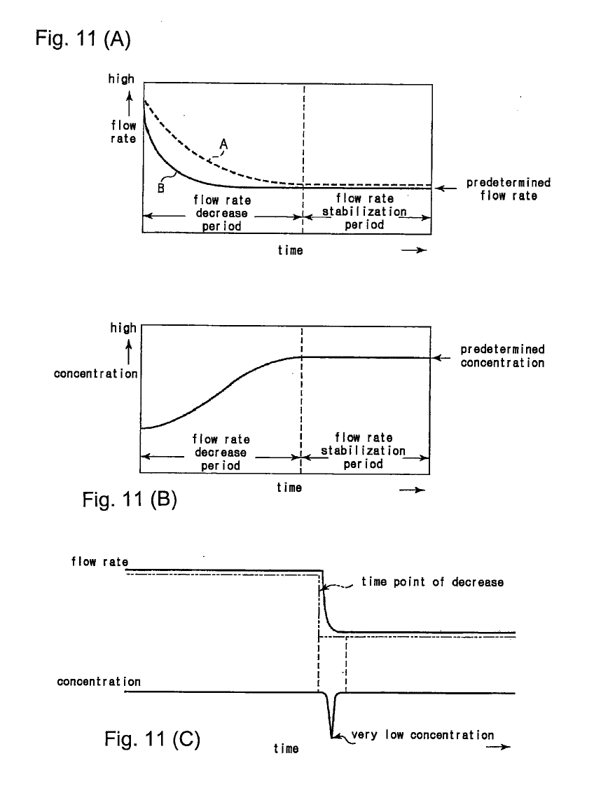

For example, as shown in FIG. 11a, when a first liquid A is deionized water, and a second liquid B is hydrofluoric acid, the flow rate of hydrofluoric acid is more rapidly decreased than that of deionized water. Accordingly, as shown in FIG. 11b, during the flow rate decrease period, the mixing ratio of hydrofluoric acid and deionized water can be deviated from a predetermined value, thereby temporarily forming a processing liquid with a very low concentration. The correlation between a timing at which the flow rates are decreased and the concentration of the processing liquid, is shown in FIG. 11c.

As shown in FIG. 11c, unlike the increase in the flow rate of the processing liquid, the decrease in the flow rate of the processing liquid during the liquid processing forms a very low concentrated processing liquid. Because the processing liquid which is formed by the liquids having different characteristics is supplied to the processing unit, the liquid processing of the processing unit cannot be stably performed.

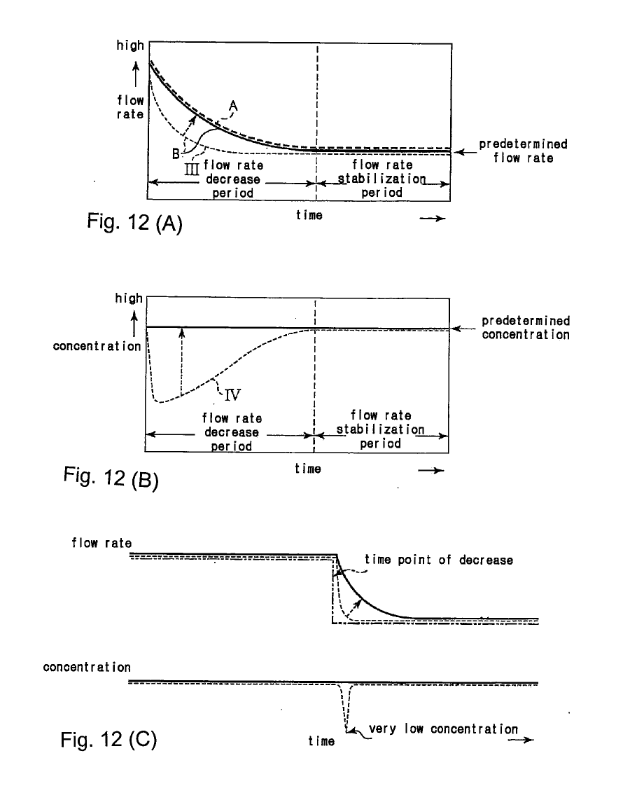

Therefore, as shown in dotted line III of FIG. 12a, when the flow rate of the second liquid B is more rapidly decreased than that of the first liquid A, the decrease rate of the flow rate of the second liquid B can be controlled to be decreased down to a predetermined flow rate while being restrained. The decrease rate of the flow rate of the second liquid B may be restrained in order to be similar to the decrease rate of the flow rate of the first liquid A. For example, for unit time, the decrease rate of the flow rate of the second liquid B can be controlled to be identical to that of the first liquid A. The decrease in the flow rate of the processing liquid is completed before the number of operating processing units increases.

The mixing ratio of the first and second liquids A and B can become varied so that the concentration of the processing liquid is deviated from a predetermined concentration. However, as shown in FIG. 12b, this deviation can be relieved even during a flow rate decrease period when the decrease rate of the flow rate of the second liquid B is controlled to be restrained, as compared to the case where the decrease rate of the flow rate of the second liquid B is not restrained as shown in dotted line IV

Therefore, as shown in FIG. 12c, even when the flow rate of the processing liquid is decreased during the liquid processing, the formation of a very low concentrated processing liquid is restrained. Thus, a processing liquid having a stabilized concentration characteristic can be provided to the processing unit via the processing liquid supply pipe 210.

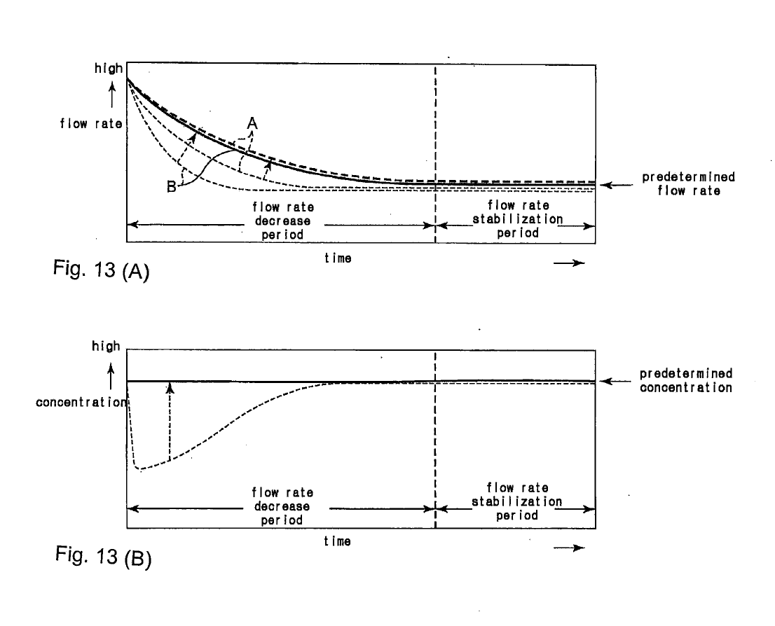

Also, when the deviation of the mixing ratio of the first and second liquids A and B from a predetermined value can be prevented by restraining both decrease rates of the flow rates of the first and second liquids A and B, the decrease rates of the flow rates of both liquids A and B as shown in FIGS. 13a to 13b may be restrained.

In some examples, the characteristics of the first and second liquids A and B may be determined, and then a control level for restraining the increase/decrease rates of the flow rates of the first and second liquids A and B may be previously recorded in a recipe.

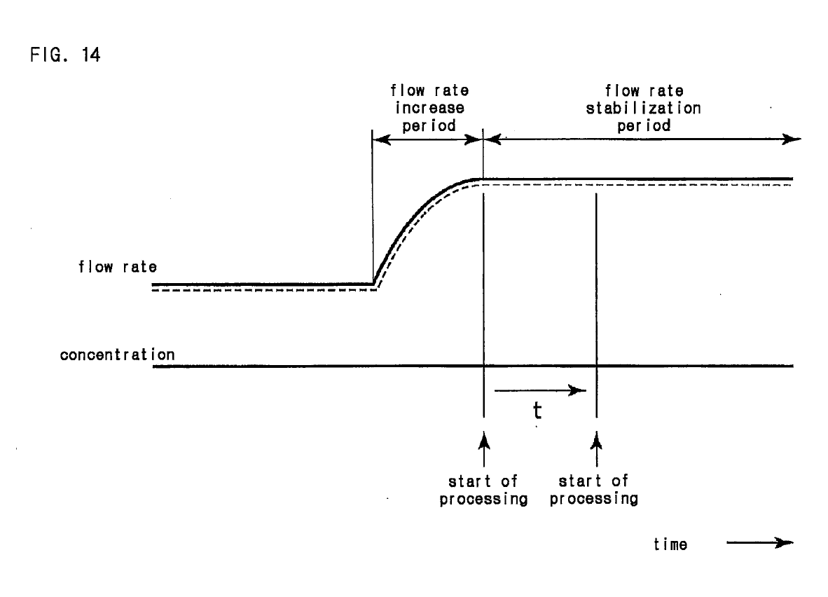

In some examples, the flow rate may be further controlled to have a stable state at a certain time, such as, a starting time of the liquid processing. For example, as shown in FIG. 14, the liquid processing may start with a predetermined time interval (t) after the flow rate becomes stabilized, rather than at the time the flow rate becomes stabilized.

In some examples, the substrate processing apparatus may include a concentration measuring part 230 to measure the concentration of a processing liquid within the common processing liquid supply pipe 210, as shown in FIG. 7, so that the flow control part 220 can be controlled according to the measured concentration. Thus, the concentration of the processing liquid can be precisely controlled. For example, the concentration measuring part 230 may include a conductivity meter. In this example, the concentration measuring part 230 is provided in a portion between the processing unit 22-1 arranged at a front end of the sequence of the processing units 22-1 to 22-6 and the mixing part 214 within the common processing liquid supply pipe 210.

The concentration measuring part 230 monitors the concentration of the processing liquid discharged from the mixing part 214. When the concentration of the processing liquid deviates from a predetermined concentration (for example, the concentration exceeds an allowable error), the concentration measuring part 230 controls at least any one of an increase/decrease rate of the first liquid A and an increase/decrease rate of the second liquid B so that an increasing or decreasing concentration of the processing liquid can be set to a preset concentration.

As described above, in the configuration of the substrate processing apparatus 200 according to the second example, the concentration of a processing liquid is adjusted to a required concentration just before the transfer of the processing liquid to a wafer W. Accordingly, the concentration of the processing liquid is not subject to a change by an increase/decrease of the flow rate of the processing liquid during the liquid processing. Thus, the processing liquid having a stabilized concentration characteristic can be supplied to the processing unit. Also, the substrate processing apparatus 200 increases or decreases the flow rate of the processing liquid according to the number of operating processing units, thereby significantly reducing a consumed amount of the processing liquid having a stabilized concentration characteristic.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

For example, although a cleaning processing apparatus to clean front/rear surfaces of a wafer is used in the above described examples, the present invention is not limited thereto but is applicable to a cleaning processing apparatus to clean any one of a front surface or a rear surface. Also, the present invention is not limited to a cleaning processing, but applicable to another liquid processing.

Also, although a semiconductor wafer is used as a target substrate in the above described examples, the present invention is applicable to other substrates, such as a substrate of a flat panel display (FPD) for example, a glass substrate of a liquid crystal display (LCD).

What is claimed is:

1. A substrate processing apparatus comprising:
a plurality of processing units to perform liquid processing on a substrate by using a processing liquid;
a processing liquid supply pipe to supply the processing liquid in common to the plurality of processing units; and
a flow control part to control a flow rate of the processing liquid within the processing liquid supply pipe to be increased or decreased according to a number of operating processing units from among the plurality of processing units,
wherein the flow control part increases the flow rate of the processing liquid within the processing liquid supply pipe before a newly operating processing unit from among the plurality of processing units operates.

2. The apparatus of claim 1, further comprising a mixing part to add a second liquid to a first liquid flowing within the processing liquid supply pipe and to form the processing liquid through mixing the first liquid with the second liquid within the processing liquid supply pipe, the second liquid being different from the first liquid,
wherein the flow control part controls a flow rate of the first liquid and a flow rate of the second liquid to be increased or decreased according to the number of the operating processing units from among the plurality of processing units, thereby increasing or decreasing the flow rate of the processing liquid within the processing liquid supply pipe.

3. The apparatus of claim 2, wherein the flow control part controls any one or both of an increase/decrease rate of the flow rate of the first liquid and an increase/decrease rate of the flow rate of the second liquid, so that the concentration of the processing liquid after increasing or decreasing of the flow rates reaches the concentration of the processing liquid before increasing or decreasing of the flow rates.

4. The apparatus of claim 1, wherein the flow control part increases the flow rate of the processing liquid within the processing liquid supply pipe, so that the newly operating processing unit operates after the increased flow rate of the processing liquid within the processing liquid supply pipe is stabilized.

5. The apparatus of claim 3, further comprising a concentration measuring part to be connected to a portion of the processing liquid supply pipe, the portion being between the mixing part and the plurality of processing units, and to measure a concentration of the processing liquid formed through the mixing in the mixing part,
wherein the flow control part controls any one or both of the increase/decrease rate of the flow rate of the first liquid and the increase/decrease rate of the flow rate of the second liquid according to the measured concentration of the concentration measuring part, so that the concentration of the processing liquid after increasing or decreasing of the flow rates reaches the concentration of the processing liquid before increasing or decreasing of the flow rates.

6. The apparatus of claim 1, further comprising a back pressure control part to be connected to a portion of the processing liquid supply pipe, the portion being between a drain and the plurality of processing units, and to control pressure of the processing liquid within the processing liquid supply pipe,
wherein the back pressure control part controls the pressure of the processing liquid within the processing liquid supply pipe to have a uniform value according to a change in the flow rate of the processing liquid within the processing liquid supply pipe.

7. The apparatus of claim 6, further comprising a pressure measuring part to be connected to a portion of the processing liquid supply pipe, the portion being between the plurality of processing units and the back pressure control part and to measure pressure within the processing liquid supply pipe,
wherein the back pressure control part changes the pressure of the processing liquid within the processing liquid supply pipe according to the measurement result of the pressure measuring part.

8. A method of liquid processing of a substrate processing apparatus, comprising:
supplying a processing liquid in common from a processing liquid supply pipe to a plurality of processing units;
controlling a flow rate of the processing liquid flowing within the processing liquid supply pipe to be increased or decreased according to a number of operating processing units from among the plurality of processing units.

9. A computer-readable storage medium, the storage medium being executed by a computer and storing a substrate processing control program,
wherein the control program controls the substrate processing apparatus to perform the method of claim 8 on execution by the computer.
